(19) United States
(12) Patent Application Publication
(10) Pub. No.: US 2007/0097064 A1
(43) Pub. Date: May 3, 2007

(54) DISPLAY CONTROL CIRCUIT, DISPLAY CONTROL METHOD AND DISPLAY APPARATUS

(76) Inventors: Mitsutaka Okita, Hakusan-shi (JP); Kenji Nakao, Kanazawa-shi (JP); Kazuhiro Nishiyama, Kanagawa-shi (JP); Daiichi Suzuki, Sendai-shi (JP); Shigesumi Araki, Ishikawa-gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/553,738

(22) Filed: Oct. 27, 2006

(30) Foreign Application Priority Data
Oct. 31, 2005 (JP) 2005-316191
Sep. 22, 2006 (JP) 2006-257662

(51) Int. Cl. G09G 3/36

(52) U.S. Cl. 345/101

(57) ABSTRACT

A display control circuit which controls a display panel on which a plurality of pixels having an optical control layer between a pair of substrates are allocated in a substantial matrix form, the circuit includes a temperature detecting unit which detects a temperature relating to a temperature of the display panel, and a display panel drive unit which periodically outputs to the each pixel a gradation signal that corresponds to a video image signal, wherein the display panel drive unit has a setting unit which sets a gradation signal corresponding to the video image signal in response to a temperature of the display panel, the temperature having been detected by the temperature detecting unit and an overdrive output unit which, in response to a change of gradation of the video image signal, outputs another gradation signal instead of the gradation signal in at least a one-cycle period after the change.

### CROSS-REFERENCE TO RELATED APPLICATIONS

This application is based upon and claims the benefit of priority from prior Japanese Patent Applications No. 2005-316191, filed Oct. 31, 2005; and No. 2006-257662, filed Sep. 22, 2006, the entire contents of both of which are incorporated herein by reference.

### BACKGROUND OF THE INVENTION

1. Field of the Invention

The present invention relates to a display control circuit, a display control method, and a display circuit for displaying an image.

2. Description of the Related Art

A flat display apparatus represented by a liquid crystal display apparatus is widely utilized as a display apparatus of a computer, a car navigation system, a television image receiver and the like. The liquid crystal display apparatus, in general, has a liquid crystal display panel including a matrix array of a plurality of liquid crystal pixels, a backlight that illuminates this liquid crystal display panel, and a display control circuit that controls these liquid crystal display panel and backlight.

In the case where the liquid crystal display apparatus is such a display apparatus that primarily displays a mobile image, there is used a liquid crystal display panel in an OCB mode in which responsivity of a liquid crystal molecule is good.

In the meantime, in the case where the liquid crystal display apparatus is utilized as a car-mounted display apparatus of a car navigation system or the like, a required use temperature range is from −20° C. to 85° C., which is very wide. In general, as the temperature of the liquid crystal display apparatus becomes low, a response speed becomes low. In the OCB mode indicating a high speed response at a normal temperature as well, if the temperature is lowered, the lowering of the response speed can be observed. On the other hand, in a car-mounted display apparatus such as a car navigation system, the display apparatus is utilized as a back monitor, thus requiring clear and sharp image display free of a problem even under a low temperature environment. Therefore, in the liquid crystal display apparatus, high response performance is required even under such a low temperature environment.

A technique described in Jpn. Pat. Appln. KOKAI Publication No. 2005-91454 is known as a conventional technique of improving the response speed. In this technique, a new frame image is generated using a prediction circuit based on the preceding and succeeding frame images, and the number of frames to be displayed increases. Further, an image is displayed by means of overdriving.

### BRIEF SUMMARY OF THE INVENTION

According to a first aspect of the present invention, there is provided a display control circuit which controls a display panel on which a plurality of pixels having an optical control layer between a pair of substrates are allocated in a substantial matrix form, the circuit comprising: a temperature detecting unit which detects a temperature relating to a temperature of the display panel; and a display panel drive unit which periodically outputs to the each pixel a gradation signal that corresponds to a video image signal, wherein the display panel drive unit has: a setting unit which sets a gradation signal corresponding to the video image signal in response to a temperature relating to a temperature of the display panel, the temperature having been detected by the temperature detecting unit; and an overdrive output unit which, in response to a change of gradation of the video image signal, outputs another gradation signal instead of the gradation signal in at least a one-cycle period after the change.

According to a second aspect of the present invention, there is provided a display control circuit which controls a display panel on which a plurality of pixels having an optical control layer between a pair of substrates are allocated in a substantial matrix form, the circuit comprising: a display panel drive unit which periodically outputs to the each pixel a gradation signal that corresponds to a video image signal; and a temperature detecting unit which detects a temperature relating to a display panel temperature, wherein the display panel drive unit has: a setting unit which sets at least a black gradation display signal and a white gradation display signal, respectively, among the gradation signals, based on a detection signal of the temperature detecting unit; and an overdrive output unit which, in response to a change of gradation of the video image signal, sets a voltage value of the white gradation display signal to be small during at least a one-cycle period after the change.

According to a third aspect of the present invention, there is provided a display control method of a display control circuit which controls a display panel on which a plurality of pixels having an optical control layer between a pair of substrates are allocated in a substantial matrix form, the method comprising: a temperature detection step of detecting a temperature relating to a temperature of the display panel; and a display panel drive step of periodically outputting to the each pixel a gradation signal that corresponds to a video image signal, wherein the display panel drive step has: a setting step of setting a gradation signal corresponding to the video image signal in response to a temperature relating to a temperature of the display panel, the temperature having been detected by the temperature detection step; and an overdrive output step of, in response to a change of gradation of the video image signal, outputting another gradation signal instead of the gradation signal in at least a one-cycle period after the change.

According to a fourth aspect of the present invention, there is provided a display apparatus comprising: a display panel on which display pixels comprising a liquid crystal layer between a pair of electrodes are allocated in a substantial matrix form; a display control circuit which controls a liquid crystal application voltage applied to the each display pixel; and a temperature detecting unit which detects a temperature relating to a temperature of the display panel, wherein the display control circuit comprises: a gradation reference voltage generating circuit which sets a gradation reference voltage based on a detection signal of the temperature detecting unit and a change of gradation of an inputted video image signal; and an output unit which selects and outputs a gradation voltage that corresponds to the video image signal, based on a gradation reference voltage outputted from the gradation reference voltage generating circuit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically depicting a circuit configuration of a liquid crystal display apparatus;

FIG. 2 is a view schematically depicting a configuration of a source driver;

FIG. 3 is a view showing in detail a sectional structure of a liquid crystal display panel;

FIG. 4 is a view showing temperature characteristics of a black display liquid crystal application voltage and a white display liquid crystal application voltage according to this display control method;

FIG. 5 is a view showing a configuration of a gradation reference voltage generating circuit;

FIG. 6 is a view showing contents of a temperature-voltage table stored in a memory;

FIG. 7 is a view showing contents of a temperature-overdrive voltage table stored in a memory;

FIG. 8 is a time chart representing a liquid crystal application voltage in a state in which a panel temperature is set to −20° C.;

FIG. 9 is a time chart representing a liquid crystal application voltage in a state in which the panel temperature is set to −20° C.; and

FIG. 10 is a time chart representing a pixel voltage in a state in which a panel temperature is set to −20° C.

### DETAILED DESCRIPTION OF THE INVENTION

### First Embodiment

Hereinafter, with reference to the accompanying drawings, a description will be given with respect to a liquid crystal display apparatus to which a display control circuit according to an embodiment of the present invention is applied. Hereinafter, a liquid crystal display apparatus using an OCB liquid crystal will be described by way of example. The present invention is not limited to this example.

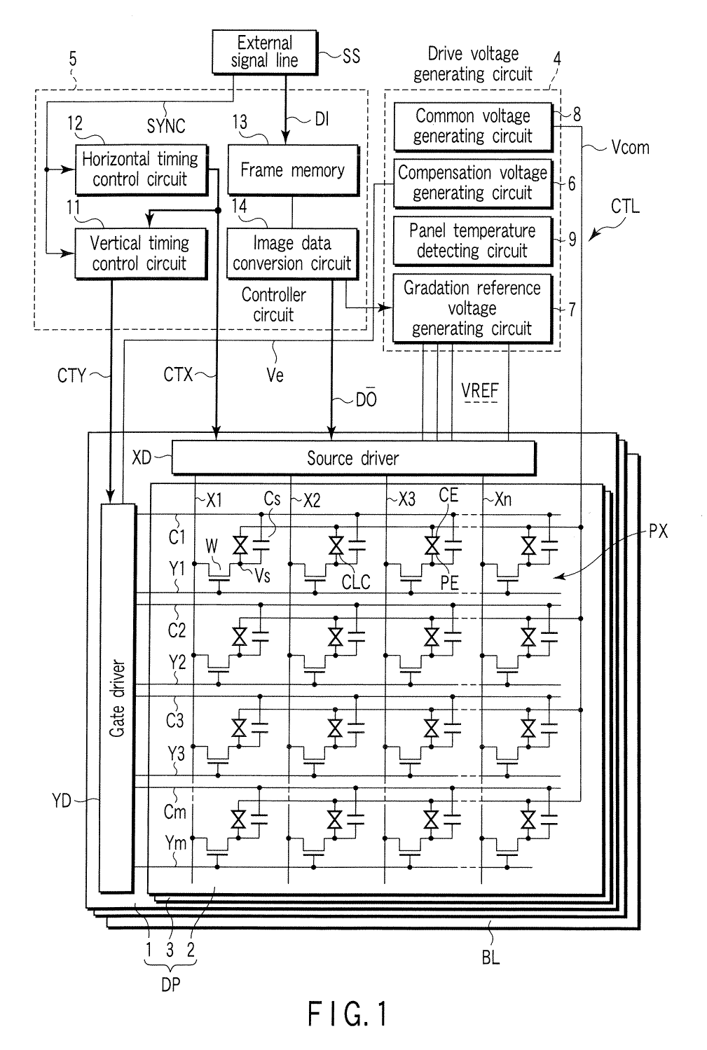

FIG. 1 is a view schematically depicting a circuit configuration of a liquid crystal display apparatus.

This liquid crystal display apparatus comprises: a liquid crystal display panel DP in an OCB mode having a plurality of OCB liquid crystal pixels PX; and a display control circuit CTL that controls the liquid crystal display panel DP and backlight BL. The liquid crystal display panel DP is structured to pinch a liquid crystal layer 3 between an array substrate 1 and an opposed substrate 2.

In the liquid crystal display panel in the OCB mode, prior to turning ON power, liquid crystal molecules are spray-aligned so as to almost lie down by means of aligned films rubbed in parallel to each other on a pixel electrode and a common electrode. The liquid crystal display panel transfers these liquid crystal molecules from a spray alignment to a bend alignment by means of a comparatively strong electric field applied by an initialization processing operation upon turning ON power, and then, a display operation is made.

In such an OCB mode, even if the current alignment is temporarily transferred to a bend alignment, in the case where a voltage applying state or a voltage non-applying state lasts for a long period of time, the voltage applying state being equal to or smaller than a level at which spray alignment energy and bend alignment energy are well balanced, the transferred bend alignment is transferred back again to the spray alignment. In the spray alignment, a display failure occurs because viewing angle characteristics are greatly different from those of the bend alignment.

Conventionally, in order to prevent reverse transition from the bend alignment to the spray alignment, for example, there is known: a drive system of applying a large voltage to an OCB liquid crystal such that reverse transition is prevented in part of a frame period for displaying an image of one frame or a drive system that does not use a voltage equal to or smaller than a level at which the spray alignment energy and the bend alignment energy are well balanced. In a normally white liquid crystal display panel, the former drive system uses a black display voltage as a reverse transition preventing voltage, whereby reverse transition can be efficiently prevented and performance of displaying a motion picture can be improved. This is referred to as black insertion drive.

This liquid crystal layer 3 is a liquid crystal of an OCB mode, and is transferred from the spray alignment to the bend alignment in advance for the purpose of a normally white display operation. In addition, reverse transition from the bend alignment to the spray alignment is inhibited by employing black insertion drive for applying a voltage at which black display is cyclically made.

A display control circuit CTL controls a transmission rate of the liquid crystal display panel DP by means of a liquid crystal drive voltage applied from the array substrate 1 and the opposed substrate 2 to the liquid crystal layer 3.

The array substrate 1 has a plurality of pixel electrodes PE, a plurality of gate lines Y (Y1, Ym), a plurality of source lines X (X1, . . . , Xn), a pixel switching element W, a gate driver YD, and a source driver XD.

The pixel electrodes PE are allocated in a matrix form on a transparent insulation substrate such as a glass, for example. The gate lines Y (Y1, . . . , Ym) are allocated along a line of the plurality of pixel electrodes PE. The source lines X (X1, . . . , Xn) are allocated along a column of the plurality of pixel electrodes PE. The pixel switching element W is allocated in the vicinity of crossing positions of these gate lines Y and source lines X. The gate driver YD sequentially drives a plurality of gate lines Y. The source driver XD drives a plurality of source lines X while each gate line Y is driven.

Each of pixel switching elements W consists of a poly-silicon thin film transistor, for example. In this case, a gate of the thin film transistor is connected to the corresponding gate line Y, and a source and a drain are connected between the corresponding source line X and one pixel electrode PE, respectively.

The gate driver YD is integrally configured on the array substrate 1 by using the poly-silicon thin film transistor formed at the same time in the same process as that in the pixel switching element W. In addition, the source driver XD is provided as an integrated circuit (IC) chip mounted on the array substrate 1 in accordance with a COG (Chip On Class) technique.

The opposed substrate 2 includes: a color filter (not shown) allocated on a transparent insulation substrate such as a glass, for example, and a common electrode CE or the like allocated on the color filter facing a plurality of pixel electrodes PE.

In the case where the liquid crystal display panel is of optical transmission type, each of the pixel electrodes PE and the common electrode CE can be composed of a transparent electrode material such as ITO. A liquid crystal molecule array of the liquid crystal layers 3 is controlled in response to an electric field from the pixel electrode PE and the common electrode CE. A pixel region composed of the pixel electrode PE, the common electrode CE, and the liquid crystal layer 3 configures an OCB liquid crystal pixel PX. In addition, the respective pixels PX have auxiliary capacitances Cs. These auxiliary capacitances Cs can be obtained by electrically connecting to the common electrode CE a plurality of auxiliary capacitance lines capacity-coupled with a plurality of pixel electrodes PE at the side thereof.

A display control circuit CTL comprises a drive voltage generating circuit 4 and a controller circuit 5. The drive voltage generating circuit 4 generates a drive voltage and a gradation reference voltage of the liquid crystal display panel DP. The controller circuit 5 controls the gate driver YD and the source driver XD.

The drive voltage generating circuit 4 includes: a compensation voltage generating circuit 6; a gradation reference voltage generating circuit 7; a common voltage generating circuit 8; and a panel temperature detecting circuit 9.

The compensation voltage generating circuit 6 generates a compensation voltage Ve applied to an auxiliary capacitance line C via the gate driver YD. This compensation voltage Ve is applied via the gate driver YD to the auxiliary capacitance line C of a line that corresponds to these switching elements W when switching elements W for one line become electrically nonconductive. The gradation reference voltage generating circuit 7 generates a predetermined number of gradation reference voltages VREF used by the source driver XD. The common voltage generating circuit 8 generates a common voltage Vcom applied to the common electrode CE. The panel temperature detecting circuit 9 detects a panel temperature or a temperature corresponding to a panel temperature by using a thermistor, for example. The gradation reference voltage VREF described previously is controlled by the temperature measured by the thermistor. A method for controlling the gradation reference voltage VREF will be described later in detail.

A temperature sensor such as a thermistor is provided on a substrate (not shown) that configures a display control circuit CTL in the present embodiment. The temperature sensor may be provided in the vicinity of the liquid crystal display panel DP or may be provided in contact with the liquid crystal display panel DP for detecting the temperature relating to the temperature of the display panel DP.

The controller circuit 5 includes a vertical timing control circuit 11, a horizontal timing control circuit 12, a frame memory 13, and an image data conversion circuit 14.

The vertical timing control circuit 11 generates a control signal CTY responsive to the gate driver YD in accordance with a sync signal SYNC inputted from an external signal source SS. The horizontal timing control circuit 12 generates a control signal CTX responsive to the source driver XD in accordance with the sync signal SYNC inputted from the external signal source SS. The frame memory 13 outputs image data from the external signal source SS on a one by one frame period basis. The image data conversion circuit 14 converts a resolution, a gradation or the like relevant to a plurality of liquid crystal pixels PX in accordance with a plurality of pixel data inputted from the frame memory 13 on a one by one frame period basis. Then, the image data conversion circuit 14 outputs an overdrive control signal (described later) to the gradation reference voltage generating circuit 7.

Image data consists of a plurality of pixel data DI relevant to a plurality of liquid crystal pixels PX, and is updated on a one by one frame period basis, for example. A control signal CTY is supplied to a gate driver YD, and a control signal CTX us supplied to a source driver XD together with pixel data DO obtained as a conversion result from the image data conversion circuit 14.

The control signal CTY is used to cause the gate driver YD to perform an operation of sequentially driving a plurality of gate lines Y, as described above. The control signal CTX is used to allocate pixel data DO to a plurality of sources lines X and to cause the source driver XD to perform an operation of specifying an output polarity.

The gate driver YD sequentially selects a plurality of gate lines Y1, . . . , Ym for gradation display and for black insertion in a one-frame period under the control of the control signal CTY; and supplies to a selection gate line Y an ON voltage serving as a drive signal for making pixel switching elements W of each line electrically conductive during a one horizontal scan period H.

The source driver XD converts each item of pixel data DO to a pixel voltage Vs with reference to a predetermined number of gradation reference voltages VREF supplied from the gradation reference voltage generating circuit 7 described above, and outputs the data in parallel to the corresponding source lines X1, . . . , Xn.

The pixel voltage Vs is provided as a voltage applied to a pixel electrode PE with a common voltage Vcom of a common electrode CE being a reference. For example, polarity is inverted with respect to the common voltage Vcom so as to carry out frame inversion drive and line inversion drive.

In addition, when the switching elements W for one line becomes electrically nonconductive, a compensation voltage Ve is applied via the gate driver YD to the auxiliary capacitance line C that corresponds to the gate line Y connected to these switching elements W. This compensation voltage is used to compensate for a fluctuation of a pixel voltage Vs generated in the pixels PX for one line depending on a parasitic capacitance of these switching elements W.

For example, when the gate driver YD drives a gate line Y1 by means of an ON voltage, and then, all of the pixel switching elements W connected to this gate line Y1 are made electrically conductive, the pixel voltage Vs on the source line X1, . . . , Xn are supplied to one end of each of the corresponding pixel electrode PE and auxiliary capacitance Cs via each of these pixel switching elements W. In addition, the gate driver YD outputs a compensation voltage Ve from the compensation voltage generating circuit 6 to an auxiliary capacitance line C1 that corresponds to this gate line Y1, and then, outputs to the gate line Y1 an OFF voltage at which these pixel switching elements W are made electrically nonconductive immediately after all of the pixel switching elements W connected to the gate line Y1 have been electrically conductive by a one horizontal scan period. When these pixel switching elements W become electrically nonconductive, the compensation voltage Ve substantially cancels fluctuation of a pixel voltage Vs influenced by these parasitic capacitances.

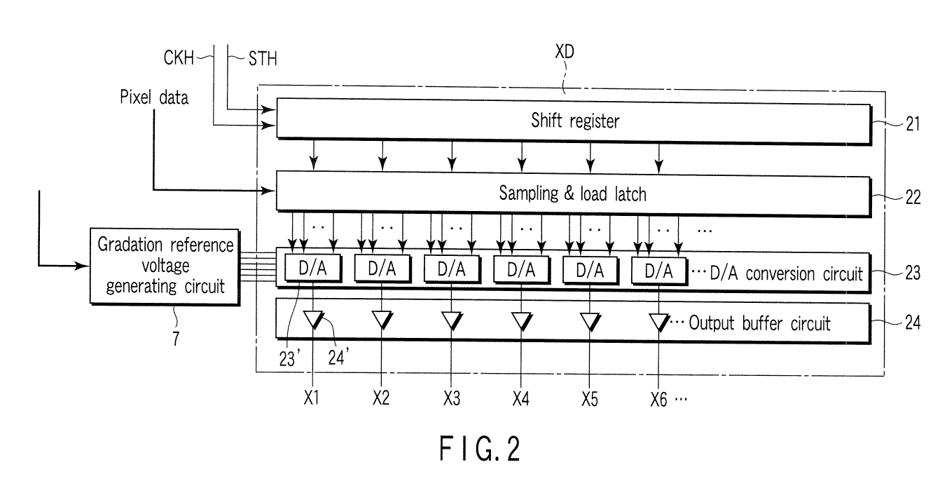

FIG. 2 is a view schematically depicting a configuration of a source driver XD.

The source driver XD includes a shift register 21, a sampling & load latch 22, a digital/analog (D/A) conversion circuit 23, and an output buffer circuit 24.

A control signal CTX includes: a horizontal start signal STH that controls a start timing of sampling pixel data for one line; and a horizontal clock signal CKH that shifts a horizontal start signal STX in the shift register 21.

The shift register 21 shifts the horizontal start signal STH in synchronism with the horizontal clock signal CKH, and then, controls a timing of sequentially converting pixel data DO in series or in parallel. The sampling & load latch 22 sequentially latches pixel data DO with respect to pixels PX for one line under the control of the shift register 21, and then, outputs the latched pixel data in parallel. The digital/analog (D/A) conversion circuit 23 converts pixel data DO to an analog format pixel voltage.

The output buffer circuit 24 outputs to source lines X1, . . . , Xn an analog pixel voltage obtained from the D/A conversion circuit 23. Then, the D/A conversion circuit 23 is configured so as to refer to a plurality of gradation reference voltages VREF generated from the gradation reference voltage generating circuit 7.

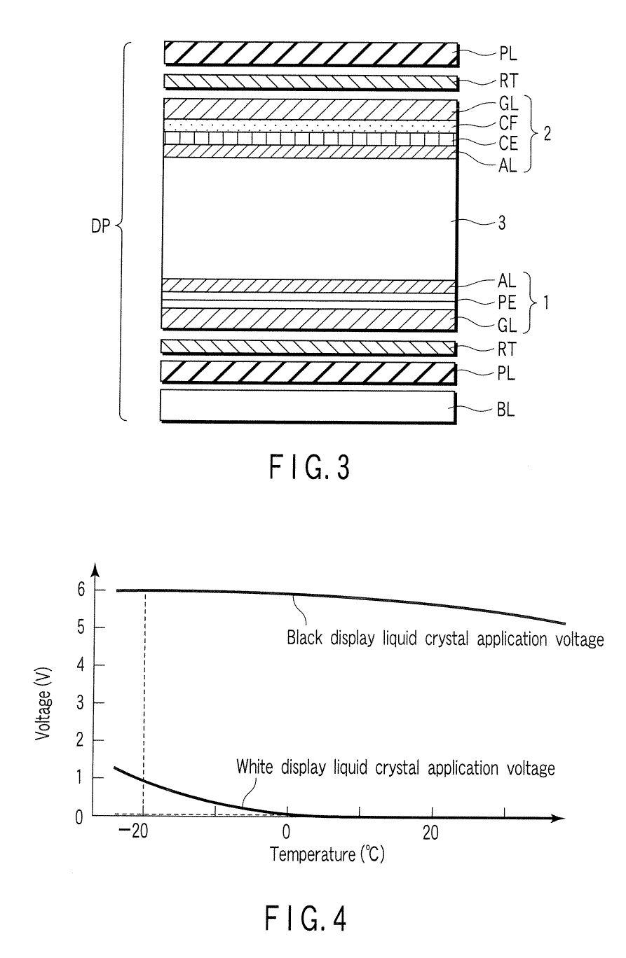

FIG. 3 is a view showing in detail a sectional structure of a liquid crystal display panel DP.

The array substrate 1 includes: a transparent insulation substrate GL made of a glass plate or the like; a plurality of pixel electrodes PE formed on this transparent insulation substrate GOL; and an alignment film AL formed on each of these pixel electrodes PE.

The opposed substrate 2 includes: a transparent insulation substrate GL made of a glass plate; a color filter layer CF formed on this transparent insulation substrate GL; a common electrode CE formed on this color filter layer CF; and an alignment film AL formed on this common electrode CE.

The liquid crystal layer 3 is constructed by filling a liquid crystal in a gap between the opposed substrate 2 and the array substrate 1.

The color filter layer CF includes: red color layer for a red pixel; green color layer for a green pixel; blue color layer for a blue pixel; and black color (light shielding) layer for a black matrix.

In addition, the liquid crystal display panel DP comprises: a pair of phase difference plates RT allocated outside the array substrate 1 and the opposed substrate 2; a pair of polarizing plates PL allocated outside these phase difference plates RT; and light source backlight BL allocated outside the polarizing plate PL at the side of the array substrate 1. The backlight BL is provided as a white color light source made of a cold cathode-ray tube or the like, and is allocated outside the polarizing plate PL at the side of the array substrate 1. The alignment film AL at the side of the array substrate 1 and the alignment film AL at the side of the opposed substrate 2 are subjected to a rubbing process in parallel to each other.

Now a description will be given with respect to a basic concept of a display control method according to the present embodiment.

FIG. 4 is a view showing temperature characteristics of a black display liquid crystal application voltage and a white display liquid crystal application voltage according to this display control method.

First, in study of a temperature influence, a difference Δn between refractive indexes of liquid crystal material increases as a temperature is lowered. As a result, there increases a voltage (optimal black voltage) for obtaining an optimal black display as the temperature is lowered, and thus, a contrast is lowered. Therefore, as shown in FIG. 4, it is necessary to increase a black display liquid crystal application voltage as a temperature of the liquid crystal display panel DP is lowered, thereby restricting the lowering of the contrast.

On the other hand, a voltage (optimal white voltage) for obtaining an optimal white display makes almost no change even if the temperature is lowered, as indicated by dotted line in the figure. For example, the white display liquid crystal application voltage is designed so that the maximum brightness and contrast can be obtained while the application voltage is 0V at around room temperature.

From such a point of view, while the black display liquid crystal application voltage at the time of a normal temperature is set to 5V, the voltage at the time of a low temperature is set to 6V, which is greater than that at the time of the normal temperature. In addition, at the time of the normal and low temperatures both, the white display liquid crystal application voltage is set to 0V. As a result, at the time of the low temperature, a dynamic range of the liquid crystal application voltage for gradation display is set to 5V at the normal temperature, for example, whereas the range is set to 6V at the low temperature, which is wider than that at the normal temperature.

In the meantime, the display response performance is lowered when a temperature is lowered, for the reason described above.

Now, a description will be given with respect to a method for improving display response performance according to the present invention.

Let us consider response performance in the case of switching and displaying a black display and a white display. A rise time τr is defined as a response time from a black display to a white display, and a fall time Td is defined as a response from a white display to a black display. In this case, the rise time τr is sufficiently longer than the fall time τd due to characteristics of liquid crystal molecules in the case of an OCB mode. For example, the fall time Td is set to about 0.9 ms, whereas the rise time τr is about 3.6 ms, which is four times as long as the fall time.

Thus, in order to effectively improve a response speed, improvement of the rise time τr may be carried out in particular. That is, it is found that advantageous effect is attained if response performance from a black display to a white display is improved.

Therefore, in a display control circuit according to the present embodiment, at the time of a low temperature, a response speed from a black display to a white display is improved by means of overdriving. At the time of achieving this technical idea, in the present embodiment, as indicated by solid line of FIG. 4, the white display liquid crystal application voltage being 0V near room temperature increases as a panel temperature is lowered. For example, when the panel temperature is set to −20° C., a control is executed so that the white display liquid crystal application voltage is set to 1 V. In this manner, where a dynamic range of the liquid crystal application voltage for gradation display ranges from 0V to 6V, its dynamic range becomes 1V to 6V, which is reduced by changing the setting of the white voltage. Then, in a low temperature state, when the black display is changed to the white display, 1V is applied as a white display liquid crystal application voltage, after 0V has been applied once as a voltage for overdriving.

By employing such a system, for example, at −20° C., a dynamic range of the liquid crystal application voltage for gradation display narrows from 6V to 5V. However, a response speed can be improved with a simple circuit configuration, as described later, without greatly influencing the display performance such as contrast.

As shown in FIG. 4, the white display liquid crystal application voltage is increased as the panel temperature is lowered, whereby the contrast may be slightly lowered. However, a nominal contrast is determined depending on a balance with a response speed, and thus, there is no large influence in terms of visibility. Therefore, it is sufficient if a voltage increase quantity is properly set at a reasonable value of a level at which the lowering of the contrast can be ignored.

Now, a description will be given with respect to a configuration and an operation of a display control circuit that achieves the display control method described above.

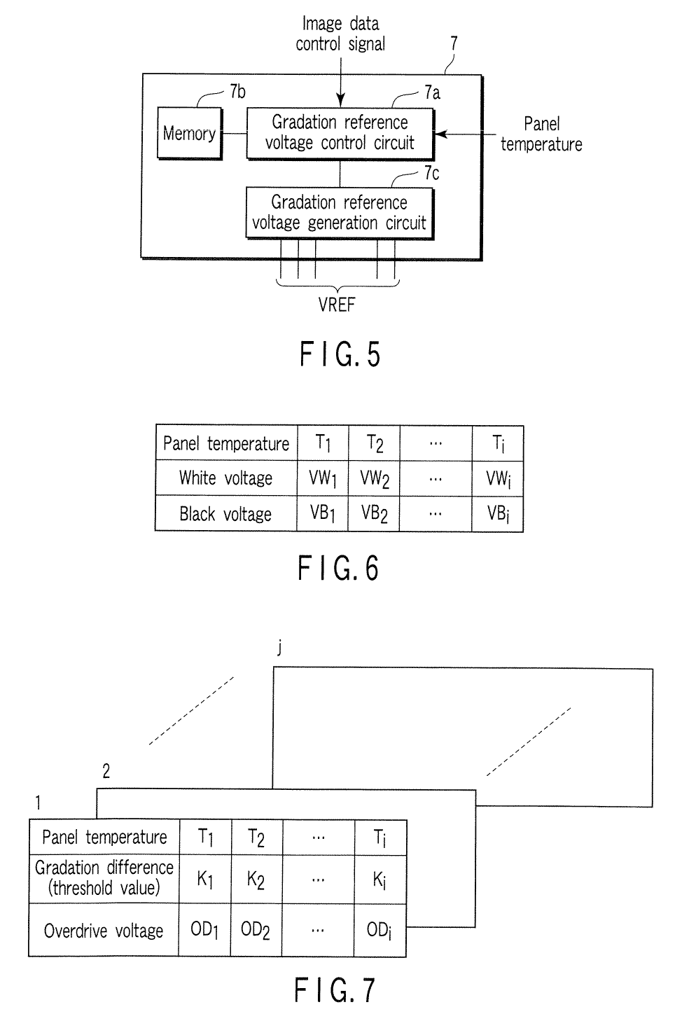

FIG. 5 is a view showing a configuration of the gradation reference voltage generating circuit 7.

The gradation reference voltage generating circuit 7 comprises: a gradation reference voltage control circuit 7a; a memory 7b; and a gradation reference voltage producing circuit 7c. To the gradation reference voltage control circuit 7a, the image data control signal is inputted from an image data conversion circuit 14, and then, a temperature relating to the panel temperature is inputted from the panel temperature detecting circuit 9.

The image data control signal includes a gradation difference between a preceding frame and a succeeding frame relevant to image data DI outputted from the external signal source SS to the frame memory 13. Although this gradation difference is desired to be obtained by individual display pixel unit, the gradation difference may be an average gradation difference of pixel line unit or frame unit.

The gradation reference voltage control circuit 7a produces a gradation reference voltage VREF that controls a white voltage and a black voltage with reference to the memory 7b in accordance with an image data control signal and a panel temperature. The memory 7b stores a reference table or the like (described later) for producing the gradation reference voltage VREF that controls the white voltage and the black voltage. The gradation reference voltage producing circuit 7c produces a plurality of gradation reference voltages VREF, and then, outputs the produced voltage to a source driver XD in accordance with a signal inputted from the gradation reference voltage control circuit 7a.

FIGS. 6 and 7 are views each showing the contents of tables stored in the memory 7b.

FIG. 6 shows a temperature-voltage table. The temperature-voltage table stores information for producing a gradation reference voltage VREF that controls a white voltage and a black voltage at each panel temperature. For example, the temperature-voltage table stores information for producing the gradation reference voltage VREF so that the white voltage is set to 0V and the black voltage is set to 5V, in the case where a panel temperature is set to a normal temperature, or alternatively, so that the white voltage is set to 1V, and the black voltage is 6V in the case where the panel temperature is set to −20° C.

FIG. 7 shows a temperature-overdrive voltage table. The temperature-overdrive voltage table stores, on a panel temperature basis, information for producing a gradation reference voltage VREF that controls an overdrive voltage in the case where a gradation difference between a preceding frame and a succeeding frame is equal to or greater than a predetermined threshold value. For example, the temperature-overdrive voltage table stores information for producing a gradation reference voltage VREF so that an overdrive voltage of 0V is selected instead of a liquid crystal application voltage of 1V in the case where a panel temperature is set to −20° C., a gradation difference is equal to or greater than 150 and a white display is carried out in a liquid crystal display apparatus displaying 256 gradations.

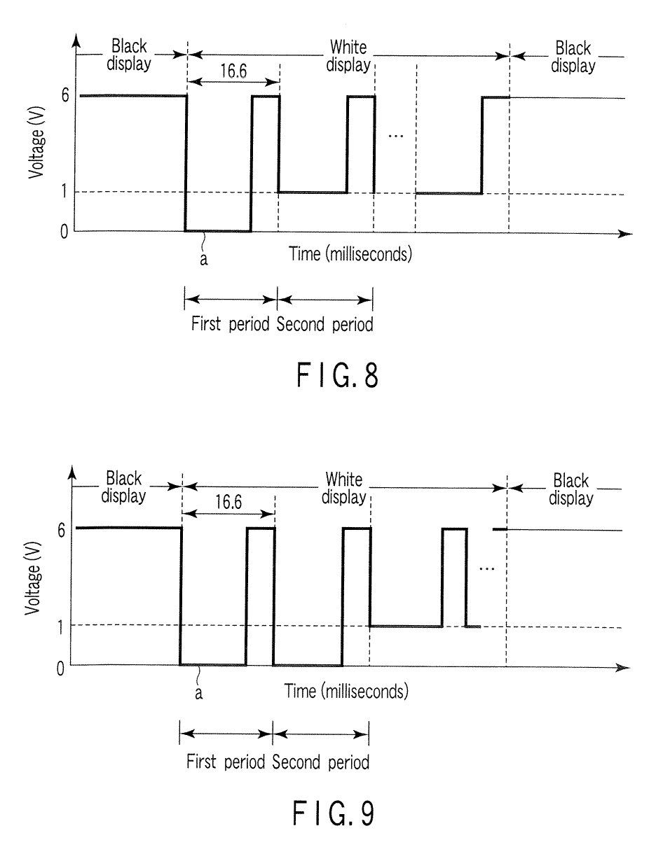

FIG. 8 is a time chart representing a liquid crystal application voltage in a state in which a panel temperature is set to −20° C. FIG. 8 shows a case in which a full black display is changed to a full white display, and further, the full white display is changed to the full black display for clarity. Hereinafter, an operation of a display control circuit will be described with reference to FIG. 8.

When image data DI for white display has been inputted from the external signal source SS to the frame memory 13, the image data conversion circuit 14 obtains a gradation difference between a preceding frame and a current frame. Then, the gradation difference information is included in an image data control signal, and then, the image data control signal is outputted to the gradation reference voltage generating circuit 7.

The gradation reference voltage control circuit 7a searches a temperature-voltage table stored in the memory 7b in accordance with a panel temperature, and then, samples information that corresponds to the temperature. In addition, this control circuit searches a temperature-overdrive voltage table stored in the memory 7b in accordance with the panel temperature, and then, samples a gradation difference threshold value and overdrive voltage information corresponding to the panel temperature.

Then, in the case where the gradation difference included in the image data control signal is greater than the gradation difference threshold value of the temperature-overdrive voltage table, information sampled from the temperature-voltage table and information sampled from the temperature-overdrive voltage table are outputted from the gradation reference voltage control circuit 7a to the gradation reference voltage producing circuit 7c.

The gradation reference voltage producing circuit 7c produces a plurality of gradation reference voltages VREF, and then, outputs the generated voltages to a source driver XD in accordance with the information sampled from the temperature-voltage table and the information sampled from the temperature-overdrive voltage table.

The subsequent operation of the source driver XD has been described in FIG. 2. A duplicate description thereof is omitted here.

By this operation, in a next white display frame (first period) that follows a black display frame shown in FIG. 8, a gradation reference voltage VREF is controlled so that a liquid crystal application voltage ranges from 1V to 6V based on information sampled from the temperature-voltage table. Further, it is determined that overdriving occurs based on the information sampled from the temperature-overdrive voltage table, and the gradation reference voltage VREF is controlled so that the liquid crystal application voltage ranges from 0V to 6V. In this manner, as shown in the figure, the liquid crystal application voltage is overdriven, and is obtained as 0V. After a predetermined time has elapsed, black insertion is carried out in order to prevent reverse transition.

In a next white display frame (second period) that follows the white display frame (first period) shown in FIG. 8, a preceding frame and a current frame each displays white, and thus, a gradation difference becomes smaller than a gradation difference threshold value. Therefore, it is determined that no overdriving occurs based on the information sampled from the temperature-overdrive voltage table; the gradation reference voltage VREF is controlled so that the liquid crystal application voltage ranges from 1V to 6V, and the liquid crystal application voltage in the second period is obtained as 1V.

In the subsequent white display period, an operation similar to that in the second period continues, and the liquid crystal application voltage is not overdriven, and is obtained as 1V.

At the time of a normal temperature, in the next white display frame (first period) that follows the black display frame, the gradation reference voltage VREF is controlled so that the liquid crystal application voltage ranges from 0V to 5V, based on the information sampled from the temperature-voltage table. Further, it is determined that no overdriving occurs based on the information sampled from the temperature-overdrive voltage table, and then, the gradation reference voltage VREF is controlled so that the liquid crystal application voltage ranges from 0V to 5V.

In the white display frame (second period) that follows the white display frame (first period) as well, similarly, the gradation reference voltage VREF is controlled so that the liquid crystal application voltage ranges from 0V to 5V.

According to the display control circuit described above, at the time of a low temperature, overdriving is carried out in an initial first period in which a black display has changed to a white display. In this manner, responsiveness of white display is improved. In addition, a dynamic range of a liquid crystal application voltage for gradation display at the time of a low temperature is substantially equal to that at the time of a normal temperature. In consideration of overdriving as well, the liquid crystal application voltage may have a dynamic range of 6V, and a burden on a circuit configuration is reduced.

In the foregoing embodiment, overdriving is not carried out at the time of white display that follows black insertion. However, in this case as well, overdriving may be carried out. In this case, the presence or absence of overdriving may be judged based on a gradation difference between black gradation and gradation of a current frame instead of a gradation difference between the preceding frame and the current frame.

In addition, the presence or absence of overdriving may be judged based on a gradation difference between gradation of a display pixel first driven after connected to an identical signal line and gradation of a display pixel driven next. This judgment is effective in the case of a large sized liquid crystal display apparatus greatly influenced by a signal line capacitance.

### Variation of First Embodiment

FIG. 9 is a time chart representing a liquid crystal application voltage in a state in which a panel temperature is set to −20° C. Like constituent elements in the first embodiment are designated by like reference numerals. A detailed description thereof is omitted here.

In a mode of this variation, overdriving is executed twice, i.e., with respect to the initial first period in which a black display has been changed to a white display and a second period. No overdriving is carried out in a third and subsequent periods. This operation is effective in the case where sufficient advantageous effect cannot be attained by means of a single-shot overdrive operation.

In order to achieve this operation, for example, when a panel temperature is equal to or smaller than a predetermined temperature, a table having specified that a two-shot overdrive operation be carried out is provided in a memory 7b. In addition, a plurality of gradation reference voltages VREF may be controlled so that a gradation reference voltage control circuit 7a carries out a two-shot overdrive operation. In the present embodiment, an overdrive operation time of each shot is set to 16.6 milliseconds. Thus, in consideration of display flickering or the like, it is thought that the overdrive repetition count is practically two at maximum.

### Second Embodiment

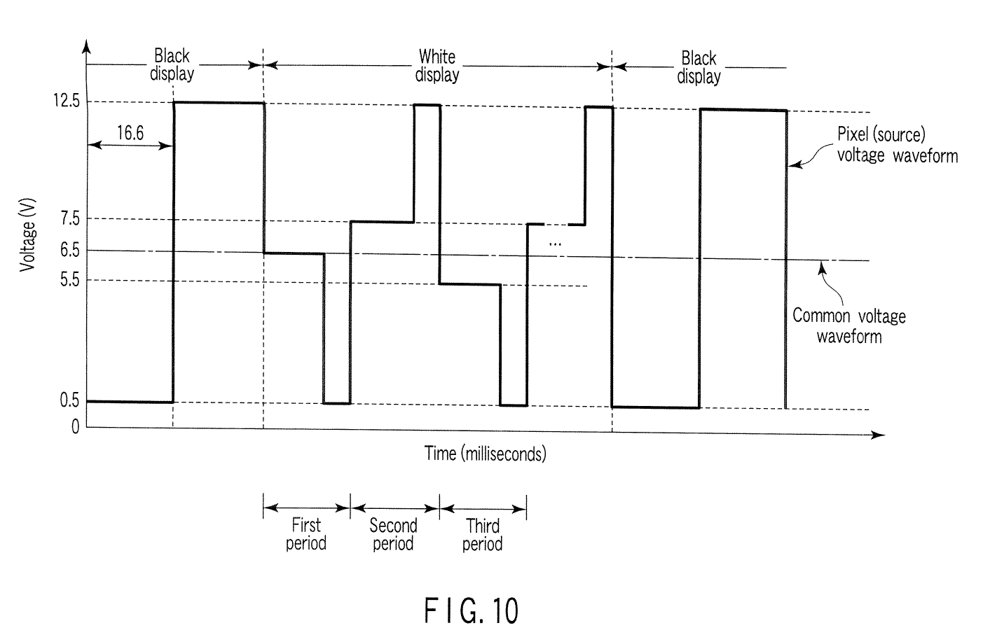

FIG. 10 is a time chart representing a pixel voltage in a state in which a panel temperature is set to −20° C. This time chart is shown in consideration of polarity. Like constituent elements in the first embodiment are designated by like reference numerals. A detailed description thereof is omitted here.

In the second embodiment, a common voltage Vcom is defined as a direct current voltage of 6.5V and polarity of a pixel voltage Vs is inverted in a frame period with respect to the common voltage Vcom.

The pixel voltage Vs at the positive polarity side is set to 7.5V at the time of a white display and is set to 12.5V at the time of a black display. A dynamic range for gradation display is obtained as 5V. In addition, the dynamic range at the time of a white display when overdriving occurs is set to 6.5V. That is, as the liquid crystal application voltage at the time of a normal white display, 1V being an electric potential difference between the pixel voltage Vs and the common voltage Vcom is applied to the liquid crystal, and, at the time of overdriving, 0V is applied to the liquid crystal.

The pixel voltage Vs on the negative polarity side is set to 5.5V at the time of a white display and is set to 0.5V at the time of a black display. The dynamic range for gradation display is set to 5V. In addition, the dynamic range at the time of a white display when overdriving occurs is set to 6.5V. That is, as the liquid crystal application voltage at the time of a normal white display, a voltage of 1V being an electric potential difference between the pixel voltage Vs and the common voltage Vcom is applied to the liquid crystal, and a voltage of 0V is applied to the liquid crystal when overdriving occurs.

In addition, in an initial frame (first period) in which a black display has been changed to a white display, overdriving is carried out, the pixel voltage Vs is set to 6.5V, and then, the liquid crystal application voltage is set to 0V.

In a next frame (second period), a white voltage is set to 7.5V at which no overdriving is carried out, and the liquid crystal application voltage is set to 1V. In a next frame (third period) or subsequent, the voltage pattern in the second period is repeated while polarity is inverted on a one by one frame basis. That is, the white voltage is set to 5.5V at which no overdriving is carried out, and the liquid crystal application voltage is set to 1V.

With such a configuration, even at the time of a low temperature, a good contrast and a high speed response can be achieved. Moreover, in a circuit configuration as well, a large withstand voltage is not required, and thus, a burden on the circuit configuration is also reduced.

In the foregoing embodiment as well, a gradation difference between a preceding frame and a succeeding frame may be obtained as a difference in average gradation value between frames, or alternatively, an overdrive voltage may be applied after a gradation difference between pixel units or between line units has been obtained.

In addition, while a control mechanism of an overdrive voltage has been provided in a gradation reference voltage generating circuit, this control mechanism may be provided in an image data conversion circuit. Further, this control function may be composed of software components or may be achieved by hardware components.

In addition, in the present embodiment, a gradation reference voltage has been controlled based on a temperature or a gradation difference. However, if a variety of gradation voltages can be provided in advance, the gradation number of pixel data may be converted based on a temperature or a gradation difference so as to select a corresponding pixel voltage, based on the thus converted pixel data.

In addition, a display control circuit according to an embodiment of the present invention can be configured as follows.

The display control circuit that has an optical control layer between a pair of substrates and that controls a display panel on which a plurality of pixels are allocated in a substantial matrix form, the circuit comprising: a display panel drive unit which outputs a first voltage that is varied in a predetermined dynamic range based on a video image signal and a second voltage different from the first voltage to the plurality of pixels; and a temperature detecting unit which detects a temperature relating to a display panel temperature, wherein the display panel drive unit has: a dynamic range selecting unit which selects either of a first dynamic range serving as the foregoing dynamic range and a second dynamic range that is narrower than the first dynamic range based on an output of the temperature detecting unit; and a voltage output unit which outputs the first voltage as a voltage being in the first dynamic range and outside the second dynamic range, when the second dynamic range is selected, and then, a voltage applied to the pixel moves from the second voltage to the first voltage.

While the foregoing embodiments have described an OCB liquid crystal display element by way of example, the present invention can be widely applied to a display control circuit comprising an optical control layer whose response performance changes depending on a temperature, without being limited to these embodiments. For example, the present invention can be widely applied to an organic EL, an inorganic EL, a TN liquid crystal, an STN liquid crystal, a VA liquid crystal and the like.

The functions described in the foregoing embodiments may be configured using hardware components. In addition, these functions may be provided while programs having described functions using software components are caused to be computer-read. In addition, each function may be configured by properly selecting any of software and hardware components.

Further, each function can be achieved by causing a computer to read programs stored in a recording medium (not shown). Here, the recording medium in the present embodiment may take any form as long as it can record a program and is computer-readable.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display control circuit which controls a display panel on which a plurality of pixels having an optical control layer are allocated in a substantial matrix form, the circuit comprising:
a temperature detecting unit which detects a temperature relating to a temperature of the display panel; and
a display panel drive unit which periodically outputs to the each pixel a gradation signal that corresponds to a video image signal,
wherein the display panel drive unit has: a setting unit which sets a gradation signal corresponding to the video image signal in response to the temperature detected by the temperature detecting unit; and
an overdrive output unit which, in response to a change of gradation of the video image signal, outputs another gradation signal instead of the gradation signal in at least a one-cycle period after the change.

2. The display control circuit according to claim 1, further comprising a gradation change detecting unit which detects that gradation value of the video image signal has changed from high gradation value to low gradation value by a predetermined gradation value or more, or has changed from low gradation value to high gradation value by a predetermined gradation value or more, and then, determines that the gradation of the video image signal has changed.

3. The display control circuit according to claim 2, further comprising an overdrive producing unit which corrects a gradation signal corresponding to the video image signal after changed with a gradation value according to the temperature, and then, produces the another gradation signal.

4. The display control circuit according to claim 1, further comprising:
a frame output unit which outputs pixel data on the video image signal to the display panel drive unit periodically on a frame by frame basis; and
a gradation change detecting unit which compares pixel data included in a previously outputted frame with pixel data included in a currently outputted frame, and then, determines that the gradation of the video image signal has changed.

5. The display control circuit according to claim 4, further comprising an overdrive producing unit which corrects a gradation signal corresponding to the video image signal after changed with a gradation value according to the temperature, and then, produces the another gradation signal.

6. The display control circuit according to claim 1, further comprising an overdrive producing unit which corrects a gradation signal corresponding to the video image signal after changed with a gradation value according to the temperature, and then, produces the another gradation signal.

7. The display control circuit according to claim 1, wherein the overdrive output unit continuously outputs the another gradation signal during a two-cycle period.

8. The display control circuit according to claim 1, wherein the overdrive output unit outputs the another gradation signal during a one-cycle period when the temperature of the display panel is lower than a first predetermined temperature.

9. The display control circuit according to claim 8, wherein the overdrive output unit continuously outputs the another gradation signal during a two-cycle period when the temperature is lower than a second predetermined temperature that is lower than the first predetermined temperature.

10. A display control circuit which controls a display panel on which a plurality of pixels having an optical control layer are allocated in a substantial matrix form, the circuit comprising:
a display panel drive unit which periodically outputs to the each pixel a gradation signal that corresponds to a video image signal; and
a temperature detecting unit which detects a temperature relating to a display panel temperature,
wherein the display panel drive unit has: a setting unit which sets at least a black gradation display signal and a white gradation display signal, respectively, among the gradation signals, based on a detection signal of the temperature detecting unit; and
an overdrive output unit which, in response to a change of gradation of the video image signal, sets a voltage value of the white gradation display signal to be small during at least a one-cycle period after the change.

11. A display control method of a display control circuit which controls a display panel on which a plurality of pixels having an optical control layer between a pair of substrates are allocated in a substantial matrix form, the method comprising:
a temperature detection step of detecting a temperature relating to a temperature of the display panel; and
a display panel drive step of periodically outputting to the each pixel a gradation signal that corresponds to a video image signal,
wherein the display panel drive step has: a setting step of setting a gradation signal corresponding to the video image signal in response to the temperature detected by the temperature detection step; and
an overdrive output step of, in response to a change of gradation of the video image signal, outputting another gradation signal instead of the gradation signal in at least a one-cycle period after the change.

12. The display control method according to claim 11, further comprising a gradation change detection step of detecting that gradation value of the video image signal has changed from high gradation value to low gradation value by a predetermined gradation value or more, or has changed from low gradation value to high gradation value by a predetermined gradation value or more, and then, determining that the gradation of the video image signal has changed.

13. The display control method according to claim 12, further comprising an overdrive producing step of correcting a gradation signal corresponding to the video image signal after changed with a gradation value according to the temperature, and then, producing the another gradation signal.

14. The display control method according to claim 11, further comprising:
a frame output step of outputting pixel data on the video image signal to the display panel drive unit periodically on a frame by frame basis; and
a gradation change detection step of comparing pixel data included in a previously outputted frame with pixel data included in a currently outputted frame, and then, determining that the gradation of the video image signal has changed.

15. The display control method according to claim 14, further comprising an overdrive producing step of correcting a gradation signal corresponding to the video image signal after changed with a gradation value according to the temperature, and then, producing the another gradation signal.

16. The display control method according to claim 11, further comprising an overdrive producing step of correcting a gradation signal corresponding to the video image signal after changed with a gradation value according to the temperature, and then, producing the another gradation signal.

17. The display control method according to claim 11, wherein the overdrive output step continuously outputs the another gradation signal during a two-cycle period.

18. The display control method according to claim 11, wherein the overdrive output step outputs the another gradation signal during a one-cycle period when the temperature of the display panel is lower than a first predetermined temperature.

19. The display control method according to claim 18, wherein the overdrive output step continuously outputs the another gradation signal during a two-cycle period when the temperature of the display panel is lower than a second predetermined temperature that is lower than the first predetermined temperature.

20. A display apparatus comprising: a display panel on which display pixels comprising a liquid crystal layer between a pair of electrodes are allocated in a substantial matrix form; a display control circuit which controls a liquid crystal application voltage applied to the each display pixel; and a temperature detecting unit which detects a temperature relating to the temperature of the display panel,
wherein the display control circuit comprises: a gradation reference voltage generating circuit which sets a gradation reference voltage based on a detection signal of the temperature detecting unit and a change of gradation of an inputted video image signal; and
an output unit which selects and outputs a gradation voltage that corresponds to the video image signal, based on a gradation reference voltage outputted from the gradation reference voltage generating circuit.

21. The display apparatus according to claim 20, wherein the gradation reference voltage generating circuit sets the gradation reference voltage so that the liquid crystal application voltage is greater as a detected temperature by the temperature detecting unit is lower.

22. The display apparatus according to claim 20, wherein the gradation reference voltage generating circuit sets the gradation reference voltage so that the liquid crystal application voltage is small in the case where a change of gradation of the video image signal is equal to or greater than a predetermined number.

23. The display apparatus according to claim 22, wherein the gradation reference voltage generating circuit sets the gradation reference voltage so that the liquid crystal application voltage is small in the case where a change of gradation of the video image signal substantially changes from a black display to a white display.

24. The display apparatus according to claim 20, wherein the liquid crystal layer is an OCB liquid crystal layer.

25. The display apparatus according to claim 20, wherein a change in gradation number of the video image signal is by the each display pixel.

26. The display apparatus according to claim 20, wherein a change in gradation number of the video image signal is by the each display pixel line.
